(19) United States
(12) Patent Application Publication
(10) Pub. No.: US 2012/0045981 A1
(43) Pub. Date: Feb. 23, 2012

(54) Nail salon workstation

(76) Inventor: Quoc Nguyen, Wall, NJ (US)

(21) Appl. No.: 12/806,680

(22) Filed: Aug. 19, 2010

(51) Int. Cl. B08B 15/00

(52) U.S. Cl. 454/49

(57) ABSTRACT

A manicure table having a technician side, an opposing client side and a table top work surface, together with an exhaust motor vacuum, a hose or pipe conduit running upwardly along the table from the vacuum toward the work surface and a controllable source of illumination at an end of the conduit adjacent to the work surface for exhausting harmful dust and noxious chemical odors generated at the work station area without shadowing the nails or nail tips being worked upon from ceiling lighting overlying the hose or pipe conduits providing the exhaust function.

### CROSS-REFERENCE TO RELATED APPLICATIONS

None.

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

NOT APPLICABLE

### BACKGROUND OF THE INVENTION

1. Field of the Invention

This invention relates to nail salon workstations, in general, and to an improved nail technician workstation for applying artificial nail tips, acrylics, or artificial nail gels, as well as for the painting of pictures or designs on nails or for the application of small decals or imitation jewels, in particular.

2. Description of the Related Art

As has been described, the previous operations of manicurist workstations typically give rise to the generation of harmful dust and noxious chemical odors. Whether the operation utilize liquid acrylics, nail polish, nail sealers or liquid adhesives, the organic and inorganic debris generated by the nail treatment or the organic debris resulting from the filing, shaping of the free edge of the nail, cuticle treatments, etc., dust and chemical odor extend throughout the salon area. For the larger salons where anywheres from 4 to 8 workstations are simultaneously in operation, it is not unusual to find the nail technicians wearing filtering masks to protect themselves from the dust and permeating odors. Such protection, on the other hand, is usually not provided to the customer or client whose nails are then being treated.

Nail salon workstations which try to deal with these problems typically include some type of ventilation system—which, however, have been found to be somewhat deficient. Analysis has shown that this results from the air vents employed usually being below the surface where the technician works with the client's hands, thereby blocking to a large extent the dust and fumes which might otherwise enter the vent system. From a health standpoint, it would be advantageous to prevent this degree of blockage from taking place.

### OBJECTS OF THE PRESENT INVENTION

It is an object of the present invention, therefore, to provide a new and improved nail salon workstation which overcomes deficiencies of the prior art.

It is an object of the present invention, also, to provide a nail salon workstation which easily and effectively clears the manicure table area of harmful dust and noxious chemical odors before they have an opportunity to deleteriously affect healthwise either the nail salon technician or the client.

It is an object of the present invention, additionally, to provide a nail salon workstation of this type able to be moved from place-to-place in a salon work area, while affording its benefits of dust and chemical odor clearings singly or in combination with other nail salon workstations of like design, in concerted action of area ventilation.

It is an object of the present invention, furthermore, to provide the harmful dust and noxious chemical odor clearings essentially right at the point where manicuring procedures are being formed so as to optimize the capture of the dust and odors before they are able to communicate down to other salon area workstations throughout a store enterprise.

### SUMMARY OF THE INVENTION

As will become clear from the following description, the present invention follows upon the recognition that to be most effective, the exhausting of this harmful dust and chemical odors is to be effectuated above the area where the technician works with his/her client's hands, at a point as near to those joint hands as possible, and in a manner such that the exhaust system does not create such shadows on the nails from overhead fluorescent or like lights which might otherwise hamper the application of artificial nail tips or the painting of pictures and/or designs on the nails—especially in close areas of work where small decals or imitation jewels are to be affixed to the nails as well.

As will be seen below, the nail salon workstation of the present invention includes a manicure table having a technician side, an opposing client side, and a table top work surface. An exhaust motor vacuum is utilized, along with a hose or pipe conduit running upwardly along the table from the vacuum toward the work surface. A controllable source of illumination is then incorporated at an end of the conduit adjacent to the work surface.

In carrying out a preferred embodiment of the invention, the controllable source of illumination includes one of a circline tube fluorescent bulb and a spot incandescent bulb—and in a preferred instance, with the controllable source of illumination being situated within the conduit itself. In such embodiment, the hose or pipe conduit is constructed to be flexible and bendable along an uppermost end thereof so as to be able to direct the illumination directly at the nails and nail tips, as desired. In the operation of the invention, the exhaust motor vacuum and the controllable source of illumination are each able to be turned “ON” and “OFF”, to facilitate the technician's job.

### BRIEF DESCRIPTION OF THE DRAWINGS

These and other features of the present invention will be more clearly understood from a consideration of the following description, taken in connection with the accompanying Drawings, in which:

FIGS. 1 and 2 are alternative perspective views helpful in an understanding of the preferred embodiment of the invention;

FIGS. 3a, 3b and 3c are helpful in an understanding of the types of controllable sources of illumination with which the nail salon workstation of the invention can operate; and

FIGS. 4a and 4b are helpful in understanding possible manners of utilizing storage enclosures of the workstation in its operation.

### DETAILED DESCRIPTION OF THE INVENTION

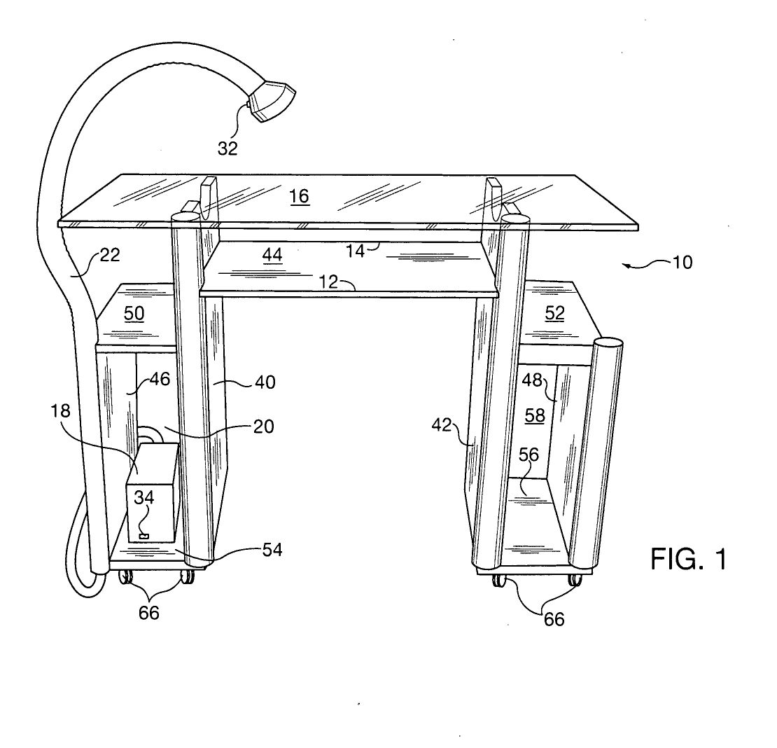

The nail salon workstation of the invention includes a manicure table 10 having a technician's side 12, an opposing client's side 14 and a table top work surface 16. An exhaust motor vacuum 18 may, as will be described below, be stored within a first enclosure 20, or which may (in an alternative version), be external thereto. A hose 22 (FIG. 1) or a pipe conduit 24 (FIG. 2)—or any combination of both—runs upwardly along the table from the vacuum 18 toward the work surface 16, and a controllable source of illumination 26 is included at the end of the hose 22 or conduit 24 adjacent to the work surface 16. In accordance with the invention, whether a hose or a pipe conduit is used, the conduit end adjacent to the work surface is flexible and bendable (as a goose-neck lamp might be) so as to allow the conduit end orientation and positioning to be adjusted by the nail technician.

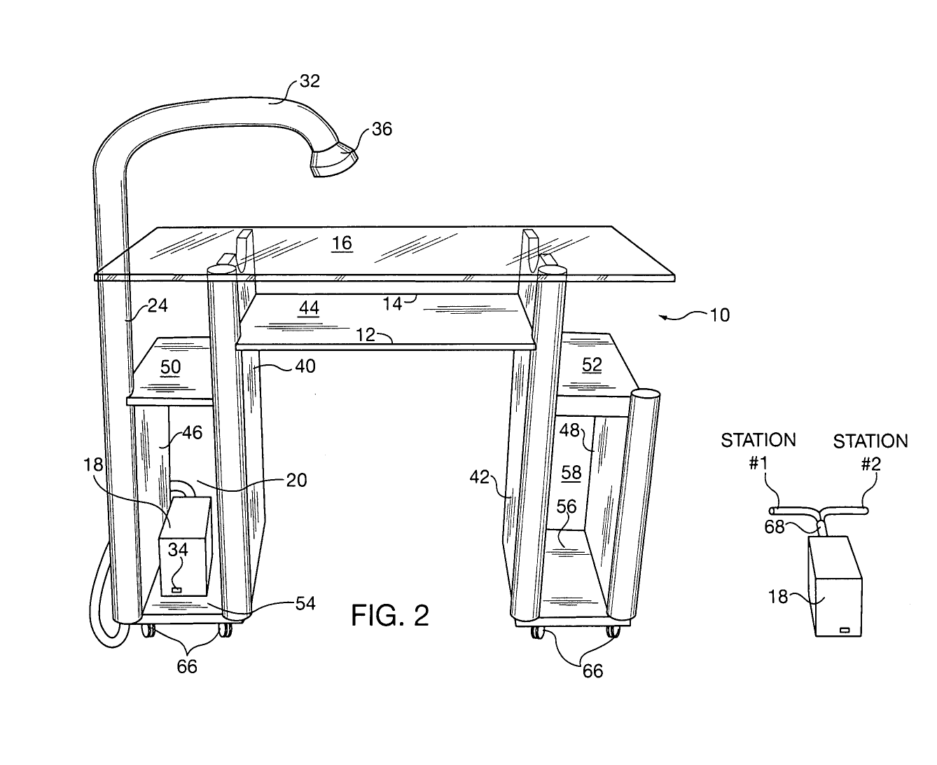

In a preferred embodiment of the invention, the controllable source of illumination 26 may be in the configuration of a circline tube fluorescent bulb 28 (FIG. 3a) or a spot incandescent bulb 30 (FIG. 3b). In this usage, the circline tube fluorescent bulb 28 or the spot incandescent bulb 30 may be situated within the hose or pipe conduit (FIG. 3c), centered so as to allow the exhaust of dust and chemical odors to be around it, substantially unlimited by the presence of the bulb to begin with. An “ON-OFF” control for the bulbs 28 and 30 is shown at 32. A like control for the exhaust motor vacuum 18 is shown at 34 in the enclosure 20.

With the motor vacuum 18 turned “ON”, and with the hose or conduit positioned by the technician at the client's hands, substantially little “shadowing” from overhead ceiling lights would be cast on the hands to interfere with the technician's artistic work. With the close proximity of the hose or pipe, any dust or chemical odors that might be generated would almost immediately be picked up by the exhaust, and dispelled via the vacuum to any outside ambient environment.

As will be seen from FIGS. 1 and 2, the manicure table 10 includes first and second spaced apart side wall legs 40, 42 for supporting the table top work surface 16, a first shelf 44 secured between interior surfaces of the first and second side wall legs 40, 42, and third and fourth side wall legs 46, 48 of lesser length than those of the side walls legs 40, 42. A second shelf 50 is secured between an interior surface of the third side wall leg 46 and an exterior surface of the first side wall leg 40, while a third shelf 52 is secured between an interior surface of the fourth side wall leg 48 and an exterior surface of the second side wall leg 42. As also will be seen, the table top work surface 16 extends over the second and third shelves 50, 52, and is optically transparent along its length. Such transparency allows the client to observe the various tools employed by the technician in performing the manicuring function, along with any additional items as sterilizing machines, ultraviolet gel machines and fingernail soak bowls that might be employed in a manicure operation.

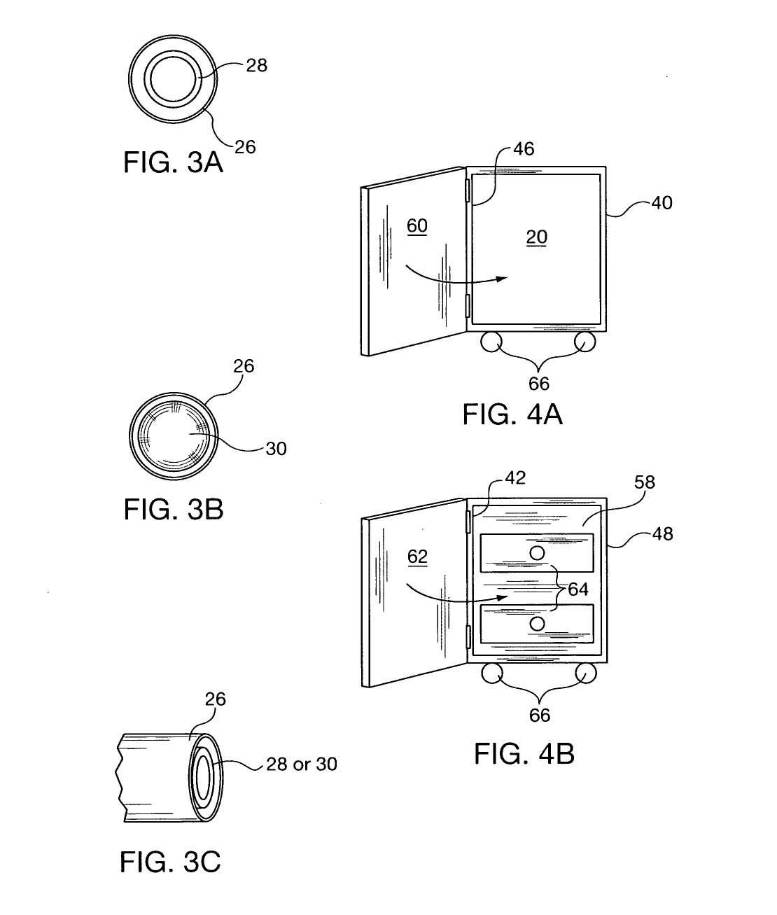

To such end, the nail salon workstation of the invention also includes fourth and fifth shelves 54, 56 respectively secured between the exterior surface of the first side wall leg 40 and the interior surface of the third side wall leg 46 and between the exterior surface of the second side wall leg 42 and the interior surface of the fourth side wall leg 48 at their bottom edges in forming not only the first enclosure 20, but also in forming a second enclosure 58. When the exhaust motor fan 18 is stored within the first enclosure 20, a door 60 may be hinged between front surfaces of the first and third side wall legs 40, 46 for opening and/or closing off the enclosure (FIG. 4a). A like door 62 may similarly be hinged between front surfaces of the second and fourth side wall legs 42, 48 (FIG. 4b) for opening and/or closing off the second enclosure 58, illustrated as being provided with a series of storage drawers 64. For moving the manicure table about, any appropriate roller assembly of casters, wheels, etc. 66 is secured at undersides of the fourth and fifth shelves 54, 56, or at bottom edges of the first, second, third and fourth side wall legs 40, 42, 46 and 48 in moving the manicure table 10 to different workstations throughout the nail salon.

In this respect, it will also be understood that a T-type coupling 68 could be employed as shown in the inset of FIG. 2 for connecting the exhaust motor vacuum 18 to serve two or more individual manicure table workstations, although in such an arrangement, individual “ON-OFF” controls would be included at the individual workstation for activating the exhaust required there from a construction in which the exhaust vacuum motor control is always turned “ON”. In such arrangement, only one exhaust motor vacuum would be needed to service the two manicure tables simultaneously. In these respects, FIG. 1 will be appreciated to include a hose type conduit for providing the exhaust action for a manicure table while a pipe type conduit is employed in the embodiment of FIG. 2. In each, however, the flexible bendable end is incorporated at the uppermost position adjacent the table top work surface to rid such area as quickly as possible of any harmful dust or noxious chemical odors that may be created.

While there have been described what are considered to be preferred embodiments of the present invention, it will be readily understood that modifications may be made by those skilled in the art without departing from the scope of the teachings herein. For at least such reason, therefore, resort should be had to the claims appended hereto for a true understanding of the invention.

I claim:

1. A nail salon workstation, comprising:
a manicure table having a technician side, an opposing client side, and a table top work surface;
an exhaust motor vacuum;
a hose or pipe conduit running upwardly along said table from said vacuum toward said work surface; and
a controllable source of illumination at an end of said conduit adjacent to said work surface.

2. The nail salon workstation of claim 1 wherein said hose or pipe conduit is flexible and bendable along an uppermost end thereof.

3. The nail salon workstation of claim 2 wherein said controllable source of illumination includes one of a circline tube fluorescent bulb and a spot incandescent bulb.

4. The nail salon workstation of claim 2, also including means for individually turning said exhaust motor vacuum and said controllable source of illumination “ON” and “OFF”.

5. The nail salon workstation of claim 3 wherein said controllable source of illumination is situated within said conduit.

6. The nail salon workstation of claim 4 wherein said manicure table includes:
first and second spaced apart side wall legs for supporting said table top work surface, a first shelf secured between interior surfaces of said first and second side wall legs, third and fourth side wall legs of lesser length than that of said first and second side wall legs, a second shelf secured between an interior surface of said third side wall leg and an exterior surface of said first side wall leg, a third shelf secured between an interior surface of said fourth side wall leg and an exterior surface of said second side wall leg, and wherein said table top work surface extends over said second and third shelves and is optically transparent along the length thereof.

7. The nail salon workstation of claim 6 wherein said manicure table also includes fourth and fifth shelves respectively secured between said interior surface of said third side wall leg and said exterior surface of said first side wall leg at bottom edges thereof, and between said interior surface of said fourth side wall leg and said exterior surface of said second side wall leg at bottom edges thereof, for forming first and second enclosures.

8. The nail salon workstation of claim 7 wherein said exhaust motor vacuum is stored within one of said first and second enclosures.

9. The nail salon workstation of claim 8 wherein said other of said first and second enclosures houses one or more drawers.

10. The nail salon workstation of claim 9, also including at least one hinged door between front surfaces of said first and third side wall legs and between front surfaces of said second and fourth side wall legs for individually opening and closing either or both of said first and second enclosures, respectively.

11. The nail salon workstation of claim 10, further including a roller assembly at undersides of said fourth and fifth shelves or at bottom edges of said first, second, third and fourth side walls legs for moving said manicure table from place-to-place.

12. The nail salon workstation of claim 11, additionally including ones of sterilizing machines, ultraviolet gel machines, technician tools and fingernail soak bowls atop said second and third shelves.

13. The nail salon workstation of claim 5 wherein said manicure table includes:
first and second spaced apart side wall legs for supporting said table top work surface, a first shelf secured between interior surfaces of said first and second side wall legs, third and fourth side wall legs of lesser length than that of said first and second side wall legs, a second shelf secured between an interior surface of said third side wall leg and an exterior surface of said first side wall leg, a third shelf secured between an interior surface of said fourth side wall leg and an exterior surface of said second side wall leg, and wherein said table top work surface extends over said second and third shelves and is optically transparent along the length thereof.

14. The nail salon workstation of claim 13 wherein said manicure table also includes fourth and fifth shelves respectively secured between said interior surface of said third side wall leg and said exterior surface of said first side wall leg at bottom edges thereof, and between said interior surface of said fourth side wall leg and said exterior surface of said second side wall leg at bottom edges thereof, for forming first and second enclosures.

15. The nail salon workstation of claim 14 wherein said exhaust motor vacuum is stored within one of said first and second enclosures.

16. The nail salon workstation of claim 15 wherein said other of said first and second enclosures houses one or more drawers.

17. The nail salon workstation of claim 16, also including at least one hinged door between front surfaces of said first and third side wall legs and between front surfaces of said second and fourth side wall legs for individually opening and closing either or both of said first and second enclosures, respectively.

18. The nail salon workstation of claim 17, further including a roller assembly at undersides of said fourth and fifth shelves or at bottom edges of said first, second, third and fourth side walls legs for moving said manicure table from place-to-place.

19. The nail salon workstation of claim 18, additionally including ones of sterilizing machines, ultraviolet gel machines, technician tools and fingernail soak bowls atop said second and third shelves.
